(19) United States
(12) Patent Application Publication
(10) Pub. No.: US 2008/0150372 A1
(43) Pub. Date: Jun. 26, 2008

(54) Switching circuit and control method thereof

(75) Inventors: Ying-Chian Kang, Taoyuan Hsien (TW); Heng-Sheng Su, Taoyuan Hsien (TW); Chi-Kai Lin, Taoyuan Hsien (TW); Hua-Sheng Shih, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/889,816

(22) Filed: Aug. 16, 2007

(30) Foreign Application Priority Data
Dec. 22, 2006 (TW) 095148399

(51) Int. Cl. H02B 1/24

(52) U.S. Cl. 307/128

(57) ABSTRACT

A switching circuit includes a direct current supplying circuit, an alternating current supplying circuit, a magnetic element and a load. The direct current supplying circuit provides a direct current power. The alternating current supplying circuit is electrically connected to the direct current supplying circuit and provides an alternating current power. The magnetic element is electrically connected to the direct current supplying circuit and the alternating current supplying circuit. The magnetic element is conducted or closed in accordance with the on or off state of the direct current power and the alternating current power. The load is electrically connected to the direct current supplying circuit, the alternating current supplying circuit and the magnetic element.

### CROSS REFERENCE TO RELATED APPLICATIONS

This Non-provisional application claims priority under 35 U.S.C. §119(a) on Patent Application No. 095148399 filed in Taiwan, Republic of China on Dec. 22, 2006, the entire contents of which are hereby incorporated by reference.

### BACKGROUND OF THE PRESENT INVENTION

1. Field of Invention

The present invention relates to a switching circuit and a control method thereof, and more particularly to a switching circuit composed of a magnetic element and a control method thereof.

2. Related Art

The switching circuit is one of simple but important electronic circuits. The switching element used in the switching circuit is either a reed switch or a transistor. Of course, the switching circuit may consist of a diode or a transistor in combination with a resistor or a capacitor as well.

Please refer to a reed switch 10 in FIG. 1. The reed switch 10 controls the bending of the two reeds 100, 102 in accordance with the variation in the magnetic field produced by the varying electrical current. The mechanical action of the reeds 100, 102 is converted into an electrical signal. Each of the reeds 100, 102 is a low hysteresis iron reed. The reeds 100, 102 are disposed in parallel, with a small overlapped portion in their tails. The major parts of the reeds 100, 102 are completely sealed inside a glass tube 104 filled with a kind of inert gas.

To turn on the reed switch 10 requires an extra output current. The variation in the electrical current produces a magnetic field. When the magnetic field induces an opposite and sufficiently large polarity at the overlapped portion of the reeds 100, 102, they attract and touch each other. In this case, the reed switch 10 turns on. In other words, the magnetic energy is transformed into mechanical energy. However, the reed switch 10 is difficult to be manufactured and obtain low efficiency (in converting the magnetic energy to mechanical energy), and has the problems of oxidation at the reed contact and possibly sparks during the switch. Therefore, such switches are applied in few fields.

The electronic device used as the switching element, such as a transistor, is driven by the electrical current to be used as a switch. The transistor usually operates in three working regions: the linear region, the saturation region and the cutoff region. The transistor is driven by controlling the current flowing through it. When the transistor operates in the linear region or saturation region, it is turned on. When the transistor operates in the cutoff region, it is turned off. Therefore, by controlling the current flowing through the transistor, it will operate in between different working regions. The user can then use the transistor as the switch. However, a switching circuit composed of the transistor requires an additional control circuit for controlling the on and off state of the transistor. This causes extra cost in the circuit design.

It is therefore an important subject to provide a switching circuit that can achieve the same effects without an additional control circuit as well as a control method thereof.

### SUMMARY OF THE PRESENT INVENTION

The present invention provides a switching circuit and a control method thereof without the need of an additional control circuit, therefore, the electronic circuit design is simplified, and the labor power and required time can be reduced.

A switching circuit according to the present invention includes a direct current supplying circuit, an alternating current supplying circuit and a magnetic element. The direct current supplying circuit provides a direct current power. The alternating current supplying circuit is electrically connected to the direct current supplying circuit and provides an alternating current power. The magnetic element is electrically connected to the direct current supplying circuit and the alternating current supplying circuit. The magnetic element is conducted or closed in accordance with the on or off state of the direct current power and the alternating current power.

A control method of a switching circuit according to the present invention includes the steps of imposing an alternating current power on a magnetic element so that the magnetic element provides a high resistance; and imposing a direct current power on the magnetic element so that the magnetic element provides a low resistance.

As mentioned above, in a switching circuit and a control method thereof according to the present invention, an alternating current supplying circuit and a direct current supplying circuit are usually used in an electronic circuit to control the magnetic saturation of a magnetic element. When an alternating current power is applied on the magnetic element, the magnetic element provides a high resistance, equivalent to off state of a switching element. When a direct current power is applied on the magnetic element, the magnetic element provides a low resistance, equivalent to on state of the switching element. In comparison with the related art, the present invention utilizes the alternating current supplying circuit and the direct current supplying circuit to control on and off states of the magnetic element. Therefore, no additional control circuit is required to control on or off state of the switching element. The electronic circuit design is simplified, and the labor power and required time can be reduced.

### BRIEF DESCRIPTION OF THE DRAWINGS

The present invention will become more fully understood from the detailed description given herein below illustration only, and thus is not limitative of the present invention, and wherein:

FIG. 1 is a schematic illustration showing a conventional reed switch;

FIG. 2 is a circuit diagram showing a switching circuit according to an embodiment of the present invention;

FIG. 3 is a schematic illustration showing a magnetic element according to the embodiment of the present invention;

FIG. 4 is a circuit diagram showing the switching circuit applied to a phone system; and

FIG. 5 is a flowchart showing a control method of the switching circuit according to an embodiment of the present invention.

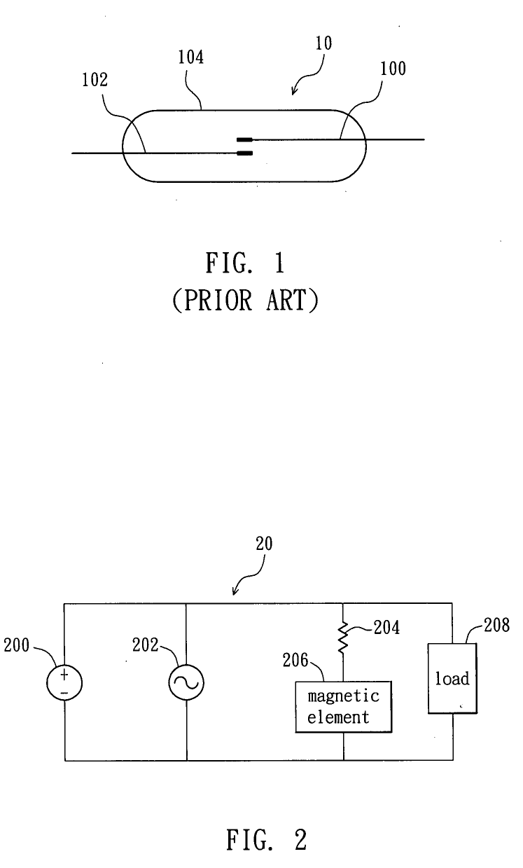

### DETAILED DESCRIPTION OF THE PRESENT INVENTION

The present invention will be apparent from the following detailed description, which proceeds with reference to the accompanying drawings, wherein the same references relate to the same elements.

As shown in FIG. 2, a switching circuit 20 according to an embodiment of the present invention includes a direct current (DC) supplying circuit 200, an alternating current (AC) supplying circuit 202, a resistor 204 and a magnetic element 206.

The DC supplying circuit 200 provides a DC power. The AC supplying circuit 202 is electrically connected to the DC supplying circuit 200 and provides an AC power. The magnetic element 206 is electrically connected to the DC supplying circuit 200 and the AC supplying circuit 202. The magnetic element 206 is conducted or closed in accordance with the on or off state of the DC power and the AC power. When the AC supplying circuit 202 continuously supplies the AC power to the switching circuit 20, the AC power flows through the magnetic element 206. As a property of the usual magnetic element, when the magnetic element 206 only receives the AC power, its iron core cannot reach the state of magnetic saturation. Thus, the magnetic element 206 provides a high resistance so that no current can flow through, and the switching circuit 20 is off. Therefore, the action of turning on or turning off of the magnetic element 206 is similar to the case that the switching circuit 20 is turning on or turning off.

To turn on the magnetic element 206, the DC supplying circuit 200 provides the DC power to the switching circuit 20 so that the DC power flows through the magnetic element 206. As a property of the usual magnetic element, when the magnetic element 206 receives the DC power, its iron core reaches the state of magnetic saturation. The resistance of the magnetic element 206 changes from high to low. Therefore, the current can flow through the magnetic element 206. In this case, the magnetic element 206 is similar to the case that the switching circuit 20 is on.

Besides, the resistor 204 is electrically connected to the magnetic element 206, the DC supplying circuit 200 and the AC supplying circuit 202. In this embodiment, the DC supplying circuit 200 and the AC supplying circuit 202 are electrically connected in parallel. The resistor 204 and the magnetic element 206 are electrically connected in series. The serially connected resistor 204 and magnetic element 206 are electrically connected in parallel with the DC supplying circuit 200 and the AC supplying circuit 202.

Moreover, the switching circuit 20 can further include a load 208. The load 208 is electrically connected to the magnetic element 206, the DC supplying circuit 200 and the AC supplying circuit 202.

By controlling the DC supplying circuit 200 and the AC supplying circuit 202, the iron core of the magnetic element 206 can be controlled to saturate magnetically or not, which in turn determines the resistance of the magnetic element 206. Consequently, the magnetic element 206 can act as a switching element.

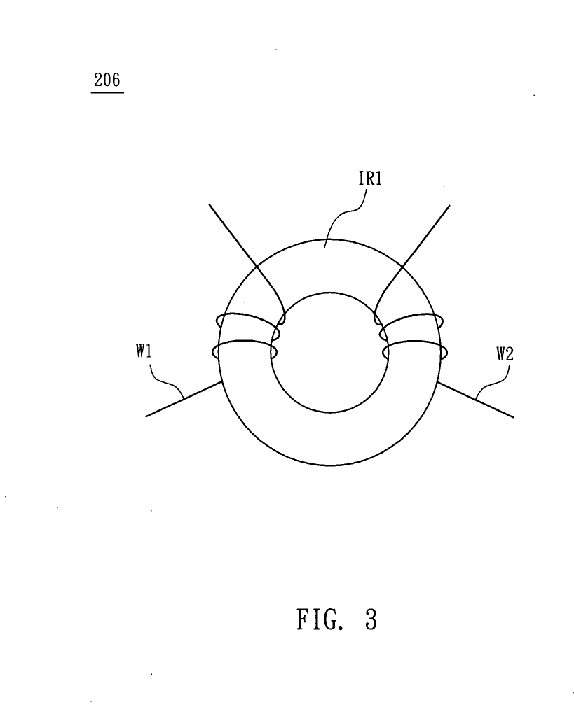

For example, the magnetic element 206 comprises a permeable element and at least one winding, and the winding is wound around the permeable element. As shown in FIG. 3, the magnetic element 206 comprises an iron core IR1 and at least one winding. In this embodiment, the magnetic element 206 comprises a first winding W1 and a second winding W2. The first winding W1 and the second winding W2 is wound around the iron core IR1, respectively. The first winding W1 or the second winding W2 can be a magnetic element 206. For example, one terminal of the first winding W1 can be connected to the resistor 204, and the other terminal of the first winding W1 can be connected to the DC supplying circuit 200 and/or the AC supplying circuit 202. The first winding W1 and the second winding W2 receive the AC power and/or DC power provided by the AC supplying circuit 202 and/or DC supplying circuit 200. By utilizing the property of the iron core IR1 under a DC bias, the magnetic element 206 reaches the state of magnetic saturation when the DC power flows through the first winding W1 or the second winding W2.

In order to describe briefly, another example is given to more explicitly explain the magnetic element 206 according to an embodiment of the present invention.

Please refer to FIG. 3 again. If the first current flowing through the first winding W1 contains both DC and AC currents, the iron core IR1 will reach the state of magnetic saturation. Whether the second current flowing through the second winding W2 contains the DC current or not, the iron core IR1 with the first winding W1 and the second winding W2 immediately change from high resistance to low resistance. The current can then easily flow through the magnetic element 206. Therefore, the magnetic element 206 acts like the on state of the switching element. Likewise, if the second current flowing through the second winding W2 contains both the DC and AC currents, the iron core IR1 reaches the state of magnetic saturation. Whether the first current flowing through the first winding W1 contains the DC current or not, the first winding W1 and the second winding W2 of the iron core IR1 immediately change from high resistance to low resistance. Therefore, the magnetic element 206 acts like on state of the switching element.

On the other hand, if the first current flowing through the first winding W1 contains only the AC current and the second current flowing through the second winding W2 contains only the AC current, the iron core IR1 cannot reach the state of magnetic saturation. In this case, the magnetic element 206 provides high resistance. Thus, it acts like the off state of the switching element. To turn off the magnetic element 206, no DC current is allowed to flow through the winding W1 or the winding W2 of the magnetic element 206. Consequently, the magnetic element 206 acts like the switching element. In another example, the magnetic element 206 is an inductor. In the following, a phone system is used to explain how the magnetic element 206 is applied.

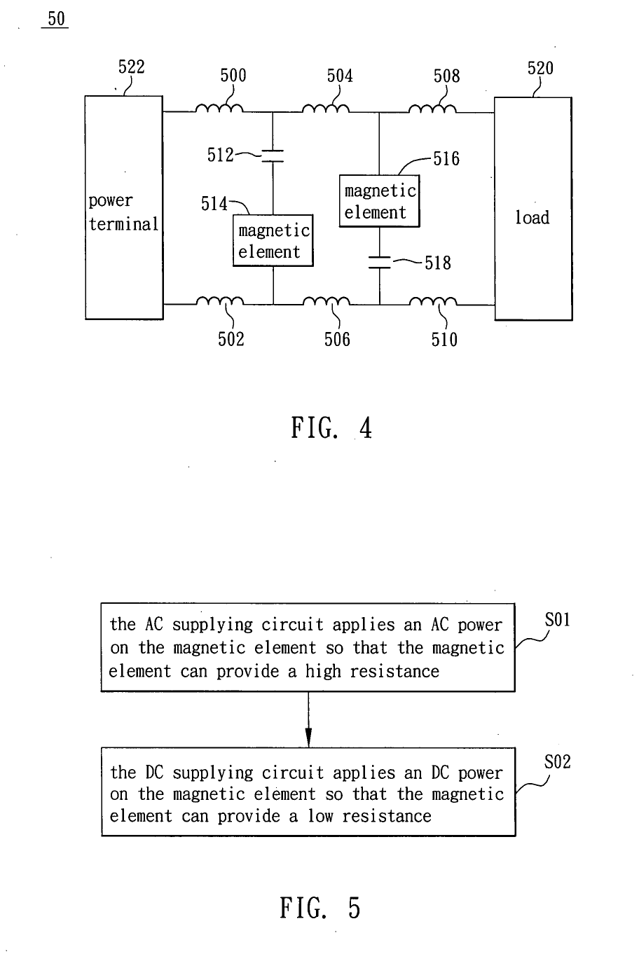

With reference to FIG. 4, the phone system 50 includes a plurality of inductors 500, 502, 504, 506, 508, 510, a plurality of capacitors 512, 518, a power terminal 522, a load 520, a first magnetic element 514 and a second magnetic element 516. The power terminal 522 is composed of a DC supplying circuit and an AC supplying circuit. The power end 522 is electrically connected to the inductors 500, 502. In this embodiment, the load 520 is a telephone machine which electrically connected to the inductors 508, 510. One terminal of the first magnetic element 514 is electrically connected to the capacitor 512. The other terminal of the first magnetic element 514 is electrically connected to the inductor 506 and the inductor 502. One terminal of the second magnetic element 516 is electrically connected to the inductor 508 and the inductor 504. The other terminal of the second magnetic element 516 is electrically connected to the capacitor 518.

When the telephone machine (the load 520) is on hook (that is, the telephone machine is not under communication), the power terminal 522 only provides the AC power. The AC power flows through the inductors 500, 504, 508 to the load 520, then through the inductors 510, 506, 502 back to the power terminal 522, forming an AC circuit. Since the AC circuit does not contain the DC current, the magnetic elements 514, 516 cannot reach the state of magnetic saturation. The magnetic elements 514, 516 provide high resistance so that no current can pass through.

When the telephone machine is switched to off hook (that is, the telephone machine is under communication), a filter is required to remove noises in the circuit for ensuring good communication quality. In the phone system 50, the filter is composed of the inductor 500 and the capacitor 512 or composed of the inductor 510 and the capacitor 518. That is, the communication signals are filtered after passing through the combination of two elements—the inductor and the capacitor. Therefore, the magnetic elements 514, 516 have to change from the off state to the on state for the communication signals to pass through the inductor and the capacitor. Here the power terminal 522 provides the AC power and the DC power to the phone system 50. When the AC and DC current provided by the power terminal 522 flows through the magnetic elements 514, 516, their iron core reach the state of magnetic saturation in accordance with the usual properties of magnetic elements. The resistances of the magnetic elements 514, 516 are lowered so that the current can pass through. Therefore, the current flows through and is filtered by the inductor and the capacitor.

In the embodiment, the magnetic elements 514, 516 comprise two windings and they affect with each other. If one of the windings such as the first winding W1 in the magnetic element 514 or in the magnetic element 516 cannot reach the state of magnetic saturation, but the other winding such as the second winding W2 in the magnetic element 514, or in the magnetic 516 reach the state of magnetic saturation, the first winding W1 can be magnetically saturated so that both the magnetic elements 514, 516 are under on state.

The magnetic elements can be driven by the original power terminal including the AC and DC power in the circuit. There is no need to utilize an additional control circuit for controlling on and off of the magnetic elements.

As shown in FIG. 5, a control method of the switching circuit according to an embodiment of the present invention includes steps S01 to S02. The switching circuit 20 in the previous embodiment can be used as an example to explain the control method.

In step S01, the AC supplying circuit 220 applies an AC power on the magnetic element 206 so that the magnetic element 206 can provide a high resistance.

In step S02, the DC supplying circuit 200 applies a DC power on the magnetic element 206 so that the magnetic element 206 can provide a low resistance.

In summary, in a switching circuit and a control method thereof according to the present invention, an electronic circuit usually provides an alternating current supplying circuit and a direct current supplying circuit to control the magnetic saturation of a magnetic element. When an alternating current power is applied on the magnetic element, the magnetic element provides a high resistance, equivalent to the off state of a switching element. When a direct current power is applied on the magnetic element, the magnetic element provides a low resistance, equivalent to the on state of the switching element. In comparison with the related art, the present invention utilizes the alternating current supplying circuit and the direct current supplying circuit to control on and off states of the magnetic element. Therefore, no additional control circuit is required to control on or off state of the switching element. By utilizing the magnetic element, the electronic circuit design is simplified, and the labor power and required time can be reduced.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A switching circuit comprising:
a direct current supplying circuit providing a direct current power;
an alternating current supplying circuit electrically connected to the direct current supplying circuit and providing an alternating current power; and
a magnetic element electrically connected to the direct current supplying circuit and the alternating current supplying circuit, and conducted or closed in accordance with the on or off state of the direct current power and the alternating current power.

2. The switching circuit of claim 1, wherein the magnetic element and the direct current supplying circuit are electrically connected in series or in parallel.

3. The switching circuit of claim 1, wherein the magnetic element and the alternating current supplying circuit are electrically connected in series or in parallel.

4. The switching circuit of claim 1, further comprising a load electrically connected to the direct current supplying circuit, the alternating current supplying circuit and the magnetic element.

5. The switching circuit of claim 1, wherein the direct current supplying circuit and the alternating current supplying circuit are electrically connected in parallel.

6. The switching circuit of claim 4, wherein the load is electrically connected in parallel to the direct current supplying circuit and the alternating current supplying circuit.

7. The switching circuit of claim 1, further comprising a resistor electrically connected to the magnetic element, the direct current supplying circuit and the alternating current supplying circuit.

8. The switching circuit of claim 7, wherein the resistor and the magnetic element are electrically connected in series.

9. The switching circuit of claim 7, wherein the resistor, the direct current supplying circuit and the alternating current supplying circuit are electrically connected in parallel.

10. The switching circuit of claim 1, wherein the magnetic element is an inductor.

11. The switching circuit of claim 1, wherein the magnetic element comprises a permeable element and at least one winding, and the winding is wound around the permeable element.

12. The switching circuit of claim 11, wherein the permeable element is an iron core.

13. The switching circuit of claim 1, wherein the magnetic element provides a low resistance when the magnetic element is conducted, and the magnetic element provides a high resistance when the magnetic element is closed.

14. The switching circuit of claim 1, being applied to a phone system, wherein the phone system comprises a plurality of inductors, a plurality of capacitors, a power terminal, a load and the magnetic element.

15. The switching circuit of claim 14, wherein the power terminal is composed of the direct current supplying circuit and the alternating current supplying circuit.

16. The switching circuit of claim 14, wherein the load is a telephone machine.

17. The switching circuit of claim 14, wherein one of the inductors and one of the capacitors act as a filter when the magnetic element is conducted.

18. A control method of a switching circuit, comprising the steps of:
applying an alternating current power on a magnetic element so that the magnetic element has a high resistance; and
applying a direct current power on the magnetic element so that the magnetic element has a low resistance.

19. The control method of claim 18, wherein the alternating current power and the direct current power are simultaneously applied on the magnetic element.

20. The control method of claim 18, wherein the magnetic element reaches the state of magnetic saturation when the direct current power is applied on the magnetic element.
